(19) United States
(12) Patent Application Publication
(10) Pub. No.: US 2025/0289584 A1
(43) Pub. Date: Sep. 18, 2025

(54) COMPUTER-IMPLEMENTED METHOD OF ESTIMATING CHARACTERISTICS OF A HYDRAULIC ACCUMULATOR OF AN AIRCRAFT

(71) Applicant: Airbus Operations Limited, Bristol (GB)

(72) Inventor: George Howell, Bristol (GB)

(21) Appl. No.: 19/076,083

(22) Filed: Mar. 11, 2025

(30) Foreign Application Priority Data
Mar. 14, 2024 (GB) 2403696.4

(51) Int. Cl. B64D 45/00; B64C 13/42

(52) U.S. Cl. CPC B64D 45/00; B64C 13/42; B64D 2045/0085

(57) ABSTRACT

A computer-implemented method of estimating characteristics of a hydraulic accumulator of an aircraft. The computer-implemented method includes obtaining pressure information representative of a pressure of hydraulic fluid in the hydraulic accumulator at a plurality of times during a mission of the aircraft, and estimating the characteristics based on the pressure information and a model including relationships between pressure and time for respective variants of the characteristics.

### TECHNICAL FIELD

The disclosure herein relates to computer-implemented methods of estimating characteristics of hydraulic accumulators of aircraft, to data processing apparatus comprising processors configured to perform such methods, to systems and aircraft comprising such data processing apparatus, and to related computer programs and computer-readable storage media.

### BACKGROUND

Aircraft comprise hydraulic accumulators that can be used as a backup source of hydraulic power in the event of a failure of an onboard primary power supply, such as in hydraulic braking systems for braking wheels of such aircraft. A pressure of hydraulic fluid in the hydraulic accumulator may vary over the course of a flight.

### SUMMARY

A first aspect of the disclosure herein provides a computer-implemented method of estimating characteristics of a hydraulic accumulator of an aircraft. The computer-implemented method comprises: obtaining pressure information representative of a pressure of hydraulic fluid in the hydraulic accumulator at a plurality of times during a mission of the aircraft; and estimating the characteristics based on the pressure information and a model comprising relationships between pressure and time for respective variants of the characteristics.

Estimating more than one characteristic may provide a more representative and/or more accurate indication of a status of the hydraulic accumulator than estimating only a single one of the characteristics. Moreover, with the present method, the estimated characteristics may be more accurate and/or more representative of respective actual characteristics of the hydraulic accumulator than, for example, characteristics estimated based on the pressure information and a model comprising relationships between pressure and time for variants in just one of the characteristics. Providing a model comprising relationships between pressure and time for variants of just one of the characteristics would require the characteristics of the hydraulic accumulator to be estimated based on a worst-case (or otherwise extreme, or average) variant in the other characteristic(s).

Optionally, the mission comprises a flight of the aircraft, which may include any one or more of: a take-off phase, a climb phase, a cruise phase, a descent phase, and a landing phase.

Utilizing the pressure information representative of the pressure in the hydraulic accumulator at the plurality of times during the mission, such as during a flight, of the aircraft may provide a more accurate estimate of the characteristics than utilizing pressure information representative of pressure at only one time during the mission of the aircraft. In particular, an accuracy of the estimated characteristics may be increased by obtaining pressure information representative of pressure in the hydraulic accumulator at a greater number of times during the mission of the aircraft, and/or over a longer period of time during the mission of the aircraft.

Optionally, the pressure information comprises a measured pressure, such as a measured pressure in an inlet and/or outlet line of the hydraulic accumulator, and/or a measured pressure in a hydraulic system to which the hydraulic accumulator is fluidically coupled. Obtaining such a measured pressure at the plurality of times during the mission of the aircraft may provide a measured relationship of pressure vs time (which may herein be referred to as a “pressure evolution”) over a period spanning the plurality of times. Optionally, the computer-implemented method comprises comparing this measured pressure evolution to plural such pressure evolutions in the model for the respective variants in the characteristics.

As more data points are obtained over a greater period of time during the mission of the aircraft, a number of pressure evolutions comprised in the model that match (or closely match) the measured pressure information may reduce, which may reduce the number of respective variants of the characteristics that provide such pressure evolutions

In this way, the characteristics may be determined to be those respective variants of the characteristics that provide a pressure evolution that most closely resembles the measured pressure evolution. This may provide an efficient and/or accurate way to estimate the characteristics. Moreover, this may provide a convenient way of estimating the characteristics without requiring sensors for sensing the characteristics directly, which may in turn reduce a weight and/or complexity of a hydraulic system comprising the hydraulic accumulator.

Optionally, the characteristics comprise: at least one mass characteristic representative of a loss of mass of fluid in the hydraulic accumulator; and at least one energy characteristic representative of a loss of energy in the hydraulic accumulator.

The pressure in the hydraulic accumulator may reduce over time during the mission of the aircraft, such as from take-off to a cruise phase. This may be due to a loss of mass of fluid in the hydraulic accumulator, such as a loss of mass of hydraulic fluid in the hydraulic accumulator, and/or due to a loss of energy in the hydraulic accumulator. For instance, a loss in mass may be due to a leakage of the fluid from the hydraulic accumulator, which may occur due to natural leakage through components of the hydraulic accumulator or components connected to the hydraulic accumulator. A loss in energy may be due to a reduction in temperature of a gas stored in the hydraulic accumulator, which may occur due to a reduction in temperature external to the aircraft, and thus external to the hydraulic accumulator, as an altitude of the aircraft increases during the mission.

The model may thereby comprise relationships between pressure and time for respective variants in the at least one mass characteristic and the at least one energy characteristic. The pressure information may comprise a measured pressure evolution, which may be compared with plural pressure evolutions comprised in the model for respective variants in the at least one mass characteristic and the at least one energy characteristic. This may advantageously allow the at least one mass characteristic and the at least one energy characteristic to be accurately determined based on the model and the pressure information alone.

The mass loss of the accumulator may be relatively constant throughout a mission of the aircraft (e.g., due to a comparatively constant leakage rate of hydraulic fluid), while the energy loss and/or temperature loss in the hydraulic accumulator may reduce over time, as a temperature of gas in the hydraulic accumulator equilibrates with a temperature external to the hydraulic accumulator and/or the aircraft. For this reason, a pressure evolution that is primarily driven by energy loss may show an initial decrease in pressure that levels-off over time. Contrarily, a pressure evolution that is primarily driven by mass loss may continue to decrease over time. Thus, by obtaining the measured pressure evolution over a greater number of time points and/or over a greater period of time during the mission of the aircraft, a level of confidence as to which variants of the mass characteristic and the energy characteristic provide such a measured pressure evolution (or the closest approximation thereto) may increase.

Optionally, the at least one mass characteristic comprises a value of pressure drop due to a loss of mass of hydraulic fluid from the hydraulic accumulator, such as due to leakage. Optionally, the at least one mass characteristic comprises a reduction in mass of fluid in the hydraulic accumulator and/or a leakage rate of hydraulic fluid from the hydraulic accumulator.

Optionally, the at least one energy characteristic comprises a value of pressure drop due to a reduction in temperature of fluid in the hydraulic accumulator and/or due to a reduction in energy stored in the hydraulic accumulator. Optionally, the at least one energy characteristic comprises a reduction in temperature of fluid in the hydraulic accumulator and/or a reduction in energy stored in the hydraulic accumulator. Optionally the temperature of fluid in the hydraulic accumulator comprises a temperature of gas stored in the hydraulic accumulator and/or a temperature of hydraulic fluid in the hydraulic accumulator.

It will be appreciated that, by estimating the characteristics based on the pressure information and the model, the characteristics may be estimated without requiring sensors for sensing, e.g., a temperature of fluid in the hydraulic accumulator, which may improve a robustness of the hydraulic accumulator by not requiring a connection to such a temperature sensor through a wall of the hydraulic accumulator. This may also permit the computer-implemented method to be applied to existing hydraulic accumulators not comprising such sensors.

Optionally, the model is based on data comprising simulated and/or experimental values of pressure over time for the respective variants of the characteristics. Utilizing simulated and/or experimental values of the pressure over time (i.e., pressure evolution) for the respective variants of the characteristics, such as values of pressure over time obtained during simulated or experimental tests of the hydraulic accumulator, may provide an accurate estimation of the characteristics, and/or may provide characteristics that are representative of the actual characteristics that lead to the obtained pressure information.

Optionally, the data comprises simulated and/or experimental values of pressure in the hydraulic accumulator, or values of pressure in a representative hydraulic accumulator. Optionally, the data comprises simulated and/or experimental values of the respective variants of the characteristics for the hydraulic accumulator, or values of the respective variants of the characteristics for a representative hydraulic accumulator.

Using simulated and/or experimental values of pressure, temperature and/or the characteristics that are associated with the hydraulic accumulator or a representative hydraulic accumulator may provide a more accurate estimation of the characteristics than, for example, using values associated with a different type of hydraulic accumulator, or by making assumptions based on an “ideal” or “worst-case” hydraulic accumulator.

Optionally, the data comprises simulated and/or experimental values of pressure over time for respective variants in one or more of the following parameters: a leakage rate of hydraulic fluid from the hydraulic accumulator or a representative hydraulic accumulator; a gas temperature of gas in the hydraulic accumulator or a representative hydraulic accumulator; a liquid temperature of liquid in the hydraulic accumulator or a representative hydraulic accumulator; a temperature external to the hydraulic accumulator or a representative hydraulic accumulator; an initial volume of hydraulic fluid in the hydraulic accumulator or the representative hydraulic accumulator; and a change or rate of change in a volume of hydraulic fluid in the hydraulic accumulator or the representative hydraulic accumulator. Optionally, the computer-implemented method comprises obtaining any one of these parameters and estimating the characteristic on the basis of such parameters. Increasing the number of such parameters may reduce a time taken to converge on a desired accuracy of the estimation using the pressure information and the model.

Optionally, the model comprises a statistical model of the relationship between the pressure, the temperature, and the characteristic, such as a regression model. Optionally, the model comprises a machine learning model that is trained on the data. By training the model on the data, an amount of the data that needs to be stored on the aircraft for use with the model may be reduced.

Providing a machine learning model may also reduce a time taken to estimate the characteristics compared, for example, to other statistical models. Moreover, the machine learning model may permit estimation of the characteristic based on input from a large number of sensors, which might be prohibitively time-consuming to implement with a human-generated statistical model. This is because a machine learning model can manage an increasing number of inputs without a significant impact on training time. A machine learning model may also reduce an impact of erroneous data on which the model is based when estimating the characteristic, such as during a flight of the aircraft, or when designing an aircraft hydraulic system comprising the hydraulic accumulator.

Optionally, the computer-implemented method comprises obtaining temperature information representative of an external temperature external to the hydraulic accumulator at each of the plurality of times during the mission of the aircraft. Optionally, the computer-implemented method comprises estimating the characteristics based on the pressure information, the temperature information, and the model, wherein the model comprises relationships between pressure and time for respective variants of the characteristics and respective variants of the external temperature.

By utilizing such temperature information, an accuracy and/or speed of the estimation of the characteristics may be improved over utilizing the model and the pressure information alone. For instance, by utilizing the temperature information, a measured pressure evolution may be compared only to pressure evolutions in the model that are associated with external temperature conditions similar to those represented by the temperature information. This may reduce a number of possible matches of pressure evolution in the model to the measured pressure evolution, which may allow the characteristics to be estimated more accurately, more quickly, and/or with fewer data points.

The temperature information may comprise any one or more of: a temperature of fluid supplied to the hydraulic accumulator; a temperature in a compartment in which the hydraulic accumulator is located, such as a brake temperature of a brake of the aircraft; a temperature external to the aircraft; and a pressurized bulkhead temperature in a pressurized bulkhead of the aircraft, such as in a cabin of the aircraft. A temperature of fluid in the hydraulic accumulator may be based on heat exchange between the fluid in the hydraulic accumulator and an atmosphere surrounding the hydraulic accumulator. This, in turn, may be based on a temperature of the atmosphere surrounding the hydraulic accumulator, which may vary based on heat exchange from the pressurized bulkhead, through the atmosphere surrounding the hydraulic accumulator (which may be located in an unpressurized zone outside of the pressurized bulkhead), and to an atmosphere external to the aircraft. The hydraulic accumulator may in particular be located in proximity to the brake of the aircraft, for instance when landing gear of the aircraft are stowed in the same compartment of the aircraft as the hydraulic accumulator. As such, the brake temperature of the brake of the aircraft may be representative of a temperature of the atmosphere surrounding the hydraulic accumulator, particularly when the brakes have cooled following an earlier braking event and/or take-off of the aircraft. An accuracy of the estimated characteristics may be improved by utilizing such temperature information.

Optionally, the computer-implemented method comprises obtaining mass information and/or volume information representative of a mass and/or volume of hydraulic fluid in the hydraulic accumulator at each of the plurality of times during the mission of the aircraft. Optionally, the computer-implemented method comprises estimating the characteristics based on the pressure information, the mass and/or volume information, the model, and optionally also the temperature information, wherein the model comprises relationships between pressure and time for respective variants of the characteristics and respective variants of the mass and/or volume (and optionally external temperature).

In a similar way to utilizing the temperature information, utilizing such mass and/or volume information may improve an accuracy and/or speed of the estimation of the characteristics compared to utilizing the model and the pressure information alone, or to using the model, pressure and temperature information alone.

The method may comprise determining the mass and/or volume, of hydraulic fluid by measuring a position of a piston and/or membrane separating the hydraulic fluid from gas in the hydraulic accumulator, such as by measuring a displacement of a rod connected to the piston and/or membrane. Optionally, the mass and/or volume of hydraulic fluid in the hydraulic accumulator may be determined by providing a magnet in the piston and/or membrane, and detecting, using a sensor external to the accumulator, a change in a magnetic field generated by the magnet as the piston and/or membrane moves. Optionally, the mass and/or volume of hydraulic fluid in the hydraulic accumulator may be determined by detecting an amount of fluid passing into and/or out of the hydraulic accumulator, such as by receiving the mass information from one or more flow rate sensors fluidically coupled to a supply pipe to and/or an output pipe from the hydraulic accumulator.

Optionally, the method comprises determining the at least one mass characteristic, such as the leakage rate, based on the mass and/or volume information. This may allow, for example, the energy characteristic to be determined based on the model, the mass characteristic, and one or more of the pressure information, the temperature information and the mass and/or volume information. Utilizing the mass characteristic in such a way may provide a more accurate estimation of the energy characteristic, and/or may reduce a time taken to converge on a desired accuracy of the estimation, as discussed above.

Optionally, the computer-implemented method comprises estimating a change in at least one of the characteristics during an upcoming portion of the mission of the aircraft. The upcoming portion of the mission may comprise a remainder of a flight of the aircraft, such as a remaining portion of the flight up until, and/or including, a landing of the aircraft, or a remaining portion of the flight up until a descent phase, an approach-to-landing phase, or any other phase of the flight of the aircraft.

Optionally, the estimating the change in the at least one of the characteristics comprises estimating a change in energy stored in and/or mass of hydraulic fluid in the hydraulic accumulator during the upcoming portion of the mission of the aircraft. This may allow the determination of an amount of energy and/or mass remaining at the end of the upcoming portion of the mission, for instance an amount of energy and/or mass available for braking wheels of the aircraft during a landing of the aircraft.

Optionally, the estimating the change in energy comprises estimating a current energy in the hydraulic accumulator and/or a current temperature in the hydraulic accumulator. Optionally, the estimating the current energy and/or current temperature in the hydraulic accumulator comprises comparing a rate of change of the temperature information, where obtained, to a threshold. For instance, an atmosphere in and/or external to the hydraulic accumulator may tend towards an equilibrium temperature (and thus an equilibrium remaining energy) during the mission of the aircraft. As such, the rate of change of the temperature information reaching the threshold may be indicative of the atmosphere in and/or external to the hydraulic accumulator reaching the equilibrium temperature. As such, when the threshold is reached, the estimated current temperature and/or estimated current energy may be based on the equilibrium temperature and/or the equilibrium energy.

Optionally, the computer-implemented method comprises estimating a period of time until an energy, mass, and/or power able to be provided by the hydraulic accumulator meets or drops below a respective threshold energy, threshold mass, and/or threshold power.

This may provide a useful indication of the remaining “availability” of the hydraulic accumulator during the current mission or future missions, such as an availability to provide suitable braking during a landing event at the end of the mission. This may improve a safety of the hydraulic accumulator. For instance, if the duration is shorter than an expected remaining mission duration, then the aircraft may be able to divert to a closer airport to maintain the availability of the hydraulic accumulator.

Optionally, the computer-implemented method comprises estimating a maximum flight duration of the current mission based on the estimated period of time.

Optionally, the computer-implemented method comprises performing an action based on the estimated change in the at least one of the characteristics, wherein the action comprises any one or more of: causing provision of a status of the hydraulic accumulator to flight crew; causing provision of instructions to flight crew; and causing control of one or more systems of the aircraft.

Optionally, the status of the hydraulic accumulator comprises the estimated period of time until the energy, mass and/or power able to be provided by the hydraulic accumulator meets or drops below the respective threshold energy, threshold mass, or threshold power, where provided. Optionally, the flight instructions comprise instructions to change the mission, such as to divert to a different airport, such as to land earlier if the estimated period of time is less than a remaining duration of the current aircraft mission.

Optionally, the controlling the one or more systems of the aircraft comprises topping up the accumulator. This may increase a mass of fluid in the hydraulic accumulator, which may increase an availability of the hydraulic accumulator to, for example, provide sufficient braking during a landing event. Optionally, the providing instructions to flight crew comprises providing instructions to top up the accumulator with hydraulic fluid manually.

Optionally, the controlling the one or more systems of the aircraft comprises controlling or adjusting a level of application of brakes that the hydraulic accumulator is configured to apply during a landing event of the aircraft in the current mission.

Optionally, the computer-implemented method comprises performing the action based on the estimated characteristics.

Optionally, the computer-implemented method comprises estimating a maximum flight duration of an upcoming mission of the aircraft.

This may be based on an expected duration of the upcoming mission, the estimated at least one mass characteristic (e.g., the leakage rate) of the hydraulic accumulator, and a predicted energy loss during the mission. The predicted energy loss may be a worst-case energy loss, for instance an energy loss based on a change in temperature from a maximum expected temperature of fluid in the hydraulic accumulator to a minimum expected temperature of the fluid in the hydraulic accumulator during the course of the mission. Using the estimated at least one mass characteristic may provide a more accurate estimated maximum flight duration than, for example, assuming a worst-case leakage rate of the accumulator.

The computer-implemented method may comprise causing provision of an indication of the maximum flight duration to flight crew and/or causing provision of instructions to change a mission of the aircraft, such as to cancel the flight and/or to fly to a different airport.

Optionally, the future mission is an upcoming flight of the aircraft, which may include any one or more of a take-off phase, a climb phase, a cruise descent phase and a landing phase.

A second aspect of the disclosure herein provides a computer program comprising instructions which, when the program is executed by a processor, cause the processor to perform the computer-implemented method of the first aspect.

It will be appreciated that the computer program may comprise and/or benefit from any of the optional features of, and/or advantages associated with, the computer-implemented method of the first aspect.

A third aspect of the disclosure herein provides a non-transitory computer-readable storage medium comprising instructions which, when executed by a processor, cause the processor to perform the computer-implemented method of the first aspect.

It will be appreciated that the non-transitory computer-readable storage medium may comprise and/or benefit from any of the optional features of, and/or advantages associated with, the computer-implemented method of the first aspect.

A fourth aspect of the disclosure herein provides a data processing apparatus comprising a processor configured to perform the computer-implemented method of the first aspect.

It will be appreciated that the data processing apparatus may comprise and/or benefit from any of the optional features of, and/or advantages associated with, the computer-implemented method of the first aspect.

A fifth aspect of the disclosure herein provides a monitoring system comprising the data processing apparatus of the fourth aspect and a pressure sensor configured to detect the pressure information representative of the pressure of hydraulic fluid in the hydraulic accumulator.

Optionally, the pressure information comprises a pressure at an inlet and/or an outlet of the hydraulic accumulator, and the pressure sensor is configured to be coupled to the inlet and/or the outlet of the hydraulic accumulator. Optionally, the pressure information comprises a pressure of the gas in the hydraulic accumulator, and the pressure sensor is configured to be coupled to a gas side of the hydraulic accumulator comprising the gas.

Optionally, the monitoring system comprises at least one temperature sensor for sensing the temperature information, where provided. Optionally, the at least one temperature sensor comprises any one or more of: a brake temperature sensor configured to sense a temperature of a brake of the aircraft; a bay temperature sensor configured to sense a temperature in a landing gear bay of the aircraft; an external temperature sensor configured to sense a temperature external to the aircraft; a bulkhead temperature sensor configured to sense a temperature in a pressurized bulkhead of the aircraft, such as in a cabin of the aircraft; and a fluid temperature sensor configured to sense a temperature of fluid provided to the hydraulic accumulator.

It will be appreciated that the monitoring system may comprise and/or benefit from any of the optional features of, and/or advantages associated with, the method of the first aspect and/or the data processing apparatus of the fourth aspect.

A sixth aspect of the disclosure herein provides a hydraulic system comprising the data processing apparatus of the fourth aspect and the hydraulic accumulator.

Optionally, the hydraulic system is an aircraft hydraulic braking system. Optionally, the hydraulic accumulator is configured to provide pressurized hydraulic fluid to a brake of the aircraft, such as in the event of a loss of integrity of a primary energy supply of the aircraft hydraulic braking system. In other words, the hydraulic accumulator may function as a back-up supply of pressurized hydraulic fluid for operating the brake. Alternatively, the hydraulic accumulator is a primary supply of hydraulic fluid for operating the brake.

Optionally, the hydraulic system is any other hydraulic system of an aircraft, such as a hydraulic system for operating flight control surfaces and/or for operating retractable landing gear of the aircraft.

It will be appreciated that the hydraulic system may comprise and/or

benefit from any of the optional features of, and/or advantages associated with, the method of the first aspect and/or the data processing apparatus of the fourth aspect.

A seventh aspect of the disclosure herein provides an aircraft system comprising the monitoring system of the fifth aspect and the hydraulic system of the sixth aspect.

Optionally, the pressure sensor is coupled to an inlet and/or an outlet of the hydraulic accumulator. Optionally, the pressure sensor is coupled to a gas side of the hydraulic accumulator, to detect a pressure of compressed gas in the gas side of the hydraulic accumulator. Optionally, the fluid temperature sensor is coupled to a fluid line of the hydraulic system, which fluid line is configured to pass fluid to the hydraulic accumulator.

It will be appreciated that the aircraft system may comprise and/or benefit from any of the optional features of, and/or advantages associated with, the method of the first aspect, the data processing apparatus of the fourth aspect, the monitoring system of the fifth aspect and/or the hydraulic system of the sixth aspect.

An eight aspect of the disclosure herein provides an aircraft comprising the data processing apparatus of the fourth aspect, the monitoring system of the fifth aspect, the hydraulic system of the sixth aspect, or the aircraft system of the seventh aspect.

It will be appreciated that the aircraft may comprise and/or benefit from any of the optional features of, and/or advantages associated with, the method of the first aspect, the data processing apparatus of the fourth aspect, the monitoring system of the fifth aspect, the hydraulic system of the sixth aspect, or the aircraft system of the seventh aspect.

### BRIEF DESCRIPTION OF THE DRAWINGS

Embodiments of the disclosure herein will now be described, by way of example only, with reference to the accompanying drawings, in which:

FIG. 1 shows an example aircraft;

FIG. 2 shows a schematic view of the aircraft of FIG. 1, including a hydraulic braking system thereof;

FIG. 3 shows an example method of estimating characteristics of a hydraulic accumulator of the hydraulic braking system shown in FIG. 2; and

FIG. 4 shows example relationships between pressure and time for respective variants in leakage rate and mass loss in the hydraulic accumulator of the hydraulic braking system shown in FIG. 2.

### DETAILED DESCRIPTION

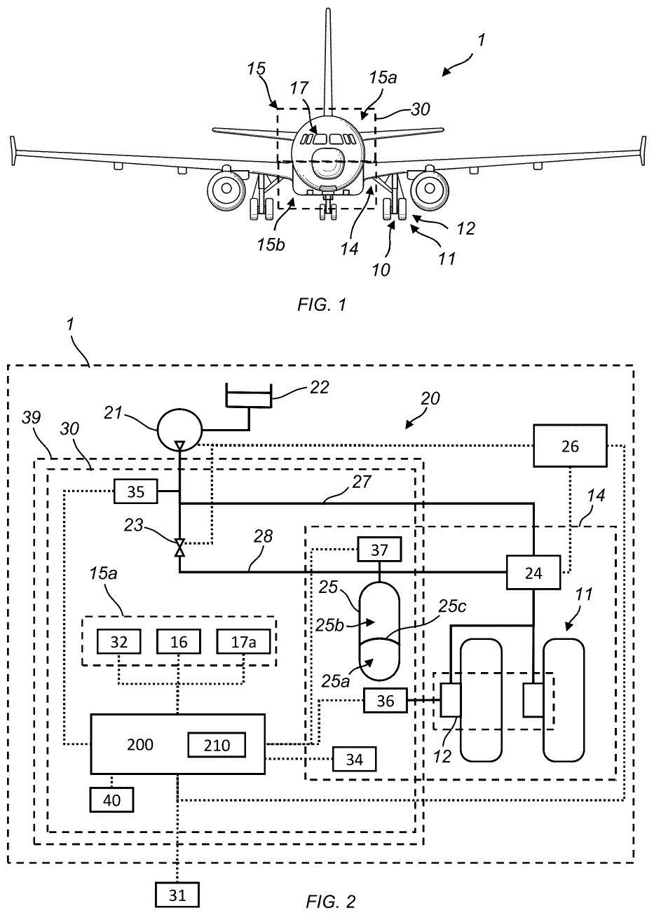

FIG. 1 shows an example aircraft 1 comprising a landing gear 10, the landing gear 10 comprising wheels 11 and brakes 12. The brakes 12 are operable to provide a braking force to the wheels 11, such as during a landing event of the aircraft 1. As shown in FIG. 2, the aircraft 1 also comprises a hydraulic braking system 20 arranged to provide pressurized hydraulic fluid to the brakes 12 to operate the brakes 12. The aircraft 1 comprises a fuselage 15 comprising a flight deck 17 and a landing gear bay 14 into which the landing gear 10 is retractable. The fuselage 15 in particular comprises a pressurized bulkhead 15a supplied with conditioned air, the pressurized bulkhead 15a including the flight deck 17, a cabin, and a cargo bay. The fuselage 15 also comprises unpressurized zones 15b, outside of the pressurized bulkhead 15a, including the landing gear bay 14, a nose gear bay, and an empennage. The aircraft 1 also comprises an aircraft sensor system 30 described in more detail below with reference to FIG. 2.

FIG. 2 shows a schematic view of the aircraft 1, the pressurized bulkhead 15a, the landing gear bay 14 (with the wheels 11 located therein when the landing gear 10 is retracted), and the hydraulic braking system 20. The hydraulic braking system 20 comprises a pump 21 for pumping pressurized hydraulic fluid from a reservoir 22 to the brakes 12. The hydraulic braking system 20 also comprises a hydraulic accumulator 25 located in the landing gear bay 14.

The hydraulic accumulator 25 in the present example comprises a pressure vessel defining a space separated into a gas space 25a and a hydraulic fluid space 25b by a flexible membrane 25c. The gas space 25a is pre-charged with gas at a specific pressure. An amount of energy stored in the gas in the gas space 25a of the hydraulic accumulator 25 is based on a temperature and a pressure of the gas in the gas space 25a. In use, pressurized hydraulic fluid is provided in the hydraulic fluid space 25b, which causes the membrane 25c to move towards the gas space 25a and reduce a volume of the gas space 25a. This increases a pressure (and thus energy stored) in the hydraulic accumulator 25. The pressurized fluid can then be caused to leave the hydraulic accumulator 25 under the action of the compressed gas in the gas space 25a, thereby to provide the stored energy in the form of pressurized hydraulic fluid to components downstream of the hydraulic accumulator 25. It will be appreciated, however, that the hydraulic accumulator 25 may take any other suitable form. For instance, the membrane 25c may instead be a piston.

The hydraulic accumulator 25 shown in FIG. 2 is fluidically coupled to the pump 21 to receive and store pressurized hydraulic fluid from the pump 21 via a refill valve 23. The hydraulic accumulator 25 and the pump 21 are fluidically coupled to the brakes 12 via a valve system 24 comprising various control valves (not shown) for delivering pressurized hydraulic fluid to the brakes 12 from the pump 21 and/or from the hydraulic accumulator 25. In particular, the hydraulic braking system 20 comprises a first fluid line 27 for supplying pressurized hydraulic fluid to the valve system 24, and a second fluid line 28 (comprising the refill valve 23) for supplying pressurized hydraulic fluid to the hydraulic accumulator 25 to recharge the hydraulic accumulator 25. The second fluid line 28 also fluidically couples the hydraulic accumulator 25 to the valve system 24. The valve system 24 may take any suitable form as will be evident to a person skilled in the art of aircraft braking systems.

The hydraulic braking system 20 also comprises a controller 26 programmed to operate the pump 21, the refill valve 23 and/or the valve system 24 to cause pressurized hydraulic fluid to be delivered to the brakes 12 from the pump 21 and/or from the hydraulic accumulator 25. In particular, the hydraulic braking system 20 is operable by the controller 26 to deliver backup power to the brakes 12 from the hydraulic accumulator 25 in the event of a loss of integrity of the pump 21, one or more valves in the valve system 24, or any other component for delivering pressurized hydraulic fluid from the pump 21 to the brakes 12. That is, the hydraulic accumulator 25 provides a backup source of hydraulic power to the brakes 12.

The aircraft sensor system 30 comprises an external temperature sensor 31 located external to the aircraft 1 to sense a temperature external to the aircraft 1, a pressurized zone temperature sensor 32 located in the pressurized zone 15a of the fuselage 15 of the aircraft 1 to sense a temperature in the pressurized zone 15a, and a bay temperature sensor 34 located in the landing gear bay 14 of the aircraft 1 to sense a temperature in the landing gear bay 14.

The aircraft sensor system 30 also comprises a fluid temperature sensor 35 fluidically coupled downstream of the pump 21 and upstream of the first and second fluid lines 27, 28, to sense a temperature of fluid provided to the brakes 12 and/or to the hydraulic accumulator 25 by the pump 21. The aircraft sensor system 30 also comprises a brake temperature sensor 36 located in proximity to the brakes 12 to sense a temperature of the brakes 12, and a pressure sensor 37 fluidically coupled to an inlet/outlet line of the hydraulic accumulator 25, to sense a pressure of hydraulic fluid at the inlet/outlet line of the hydraulic accumulator 25.

As can also be seen from FIG. 2, the pressurized bulkhead 15a, and in particular the flight deck 17 of the pressurized bulkhead 15a, comprises a flight deck system 17a and a flight controller 16 that is communicatively coupled to flight control components of the aircraft, thereby to control a flight of the aircraft 1. The flight deck system 17a comprises a flight deck display and an auditory device (not shown) located in the flight deck 17, but in other examples may comprise any other suitable device for providing information to flight crew in the flight deck 17.

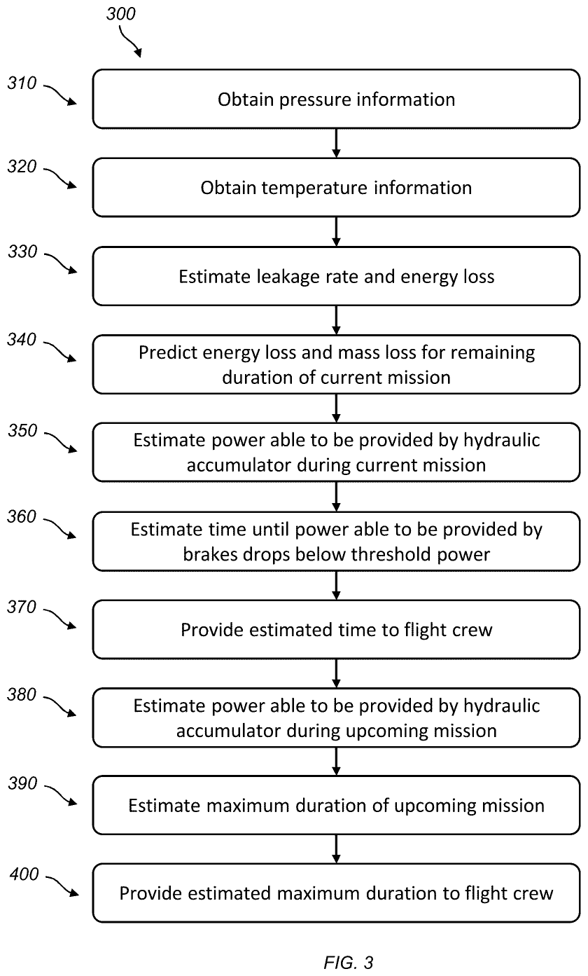

The aircraft 1 also comprises a monitor 200 communicatively coupled to each of the sensors 31, 32, 34, 35, 36, 37 in the aircraft sensor system 30, thereby to receive signals from each of the sensors 31, 32, 34, 35, 36, 37 in the aircraft sensor system 30. In particular, in the present example, the monitor 200 and the sensor system 30 together form a monitoring system 39 of the aircraft 1. The monitor 200 is programmed to use the received signals to estimate characteristics of the hydraulic accumulator 25 according to a computer-implemented method 300 that is shown in more detail in FIG. 3. In particular, the monitor 200 is communicatively coupled to a non-transitory, computer-readable storage medium 40 storing a computer program that, when implemented by a processor (210) of the monitor 200, cause the monitor 200 to perform the method 300 described below. The monitor 200 is also communicatively coupled to the flight controller 16, the hydraulic braking system controller 26, and the flight deck system 17a. This allows the monitor 20 to control an operation of the hydraulic braking system 20 via the braking system controller 26, to control an operation of the aircraft 1, and/or to adjust a mission of the aircraft 1, via the flight controller 16, and/or to provide information or instructions to flight crew via the flight deck system 17a.

The method 300 comprises obtaining 310, by the monitor 200, pressure readings from the pressure sensor 37 at plural times during a flight of the aircraft 1. In particular, the pressure readings are obtained between a start of the flight, following take-off of the aircraft, and a time during cruise of the aircraft 1. The pressure readings constitute pressure information that is representative of a pressure of the fluid in the hydraulic accumulator 25 at the plurality of times during the flight of the aircraft 1 and so provide an indication to the monitor 200 of a pressure evolution in the hydraulic accumulator 25.

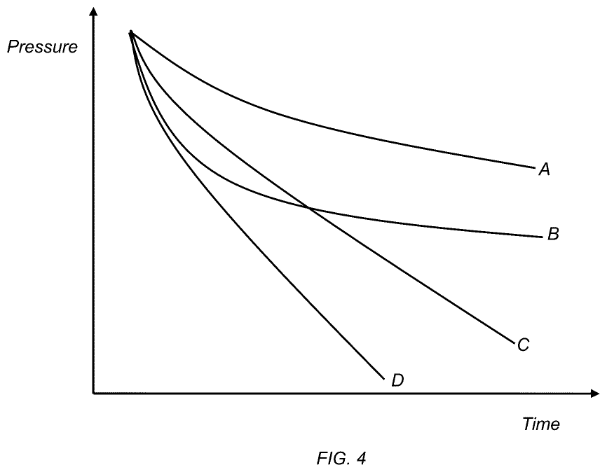

The method 300 also comprises obtaining 320 temperature information from each temperature sensor 31, 32, 34, 35, 36 in the aircraft sensor system 30, the temperature information representative of temperatures in the locations of the respective temperature sensors 31, 32, 34, 35, 36. The method 300 then comprises estimating 330 a leakage rate of hydraulic fluid from the hydraulic accumulator 25, and a loss of energy stored in the gas in the hydraulic accumulator 25 (herein “energy loss”), based on the pressure information, the temperature information, and a model comprising relationships between pressure and time for respective variants of leakage rate, energy loss and temperature. The model is stored in the computer-readable storage medium 40 to which the monitor 200 is coupled to access the model, and will be described in more detail below with respect to FIG. 4.

The method 300 comprises predicting 340 an expected energy loss and an expected mass loss expected to be experienced during a remainder of a current mission of the aircraft, based on the estimated energy loss, the estimated leakage rate, the temperature information, and a remaining duration of the current mission. The current mission comprises a current flight of the aircraft 1, including a take-off phase, a climb phase, a cruise phase, a descent phase, and a landing phase. The remainder of the current mission is a remaining (expected) duration of the mission from when the leakage rate and energy loss are estimated until the aircraft lands. The method comprises predicting 350 a power able to be delivered by the hydraulic accumulator 25 to the brakes 12 during the mission of the aircraft 1, based on the predicted expected energy loss and mass loss. The method 300 then comprises estimating 360 a period of time until the power that is able to be provided by the hydraulic accumulator 25 to the brakes 12 meets or drops below a threshold power. The threshold power is a power below which the hydraulic accumulator 25 is unable to provide sufficient (safe) braking to the wheels of the aircraft, at least for an anticipated length of a runway at which the aircraft 1 is intending to land in the current mission. The threshold power is stored in the computer-readable storage medium 40, for access by the monitor 200.

The method 300 then comprises providing 370 the estimated period of time to the flight deck system 17a for display to flight crew via the flight deck display of the flight deck system 17a. In this way, if the estimated period of time is less than an intended remaining time of the flight of the aircraft 1, the flight crew may decide to divert the aircraft 1 to an airport that is closer than an airport to which the aircraft 1 was originally flying. This may allow the aircraft 1 to land at a time when the available power is above the threshold power, for example.

The method 300 also comprises estimating 380 a power able to be delivered to the brakes 12 by the hydraulic accumulator 25 during an upcoming mission of the aircraft 1 based on the estimated leakage rate and a “worst-case” energy loss in the hydraulic accumulator 25 during the upcoming mission. The upcoming mission is an upcoming flight of the aircraft-including a take-off phase, a climb phase, a cruise phase, a descent phase, and a landing phase-upon which the aircraft 1 has not yet embarked. In other examples, the upcoming mission is a mission upon which the aircraft 1 has already embarked, but for which the monitor 200 has not yet estimated the actual leakage rate and energy loss in the hydraulic accumulator. Such a worst-case energy loss may be an energy loss that results from a drop in temperature from a maximum to a minimum anticipated temperature of the gas and/or hydraulic fluid in the hydraulic accumulator 25 during the upcoming mission.

The method 300 then comprises estimating 390 a maximum duration of the upcoming mission of the aircraft, the maximum duration being a period of time between take-off of the aircraft 1 until the estimated power for the future mission drops below a future power threshold. The future power threshold is a threshold power below which the hydraulic accumulator is unable to provide sufficient (safe) braking of the aircraft, at least for an anticipated length of a runway at which the aircraft 1 is intending to land in the upcoming mission. The method 300 comprises providing 400 the estimated maximum duration to the flight deck system 17a for indication to the flight crew via the flight deck display of the flight deck system 17a. This may allow the flight crew to take action, for example to embark on the upcoming mission if the maximum duration is longer than a planned duration of the upcoming mission. On the other hand, if the maximum duration is less than the planned duration, the flight crew may take action to cause hydraulic fluid to be provided to the hydraulic accumulator to recharge the accumulator, or to adjust the upcoming mission so that the aircraft 1 lands at a different airport, or does not embark on the upcoming mission at all. In other examples, the monitor 200 may automatically cause the flight controller 16 to cause such actions to be performed.

FIG. 4 shows example relationships between pressure and time for different variants in leakage rate and the energy loss, as comprised in the model. These relationships are stored in the computer-readable storage medium for access by the monitor 200. The relationships are generated through testing of a representative version of the hydraulic accumulator 25 (the “representative hydraulic accumulator”) under simulated flight conditions corresponding to the variants in the leakage rate and energy loss. In other examples, the relationships may be obtained in any other suitable way, such as by in-flight testing of the hydraulic accumulator 25 or the representative hydraulic accumulator, and/or by computer simulation of the hydraulic accumulator 25 under such conditions.

Line A in FIG. 4 shows a relationship between pressure and time (i.e., a pressure evolution) in the hydraulic accumulator 25 at low leakage rates and low energy losses (compared to the other lines B, C and D), while line D shows the pressure evolution in the hydraulic accumulator 25 at comparatively high leakage rates and comparatively high energy losses (with respect to the other lines A, B and C). It can be seen that the pressure drop is lowest overall when leakage rate is low and energy losses are low (line A), and that pressure drop is highest overall when leakage rate is high and energy losses are high (line D). It can be seen that the pressure in line D continues to reduce over time, due to leakage rate being generally constant, while line A levels off as a temperature of fluid in the hydraulic accumulator 25 approaches an equilibrium temperature during the flight. The equilibrium temperature is reached when the temperature of fluid (gas and hydraulic fluid) in the hydraulic accumulator 25 is substantially equal to a temperature external to the hydraulic accumulator 25, particularly a temperature in the landing gear bay 14.

Line B shows a pressure evolution at a relatively low leakage rate, similar to that of line A, but with a relatively high energy loss, similar to that of line D. On the other hand, line C shows a pressure evolution at a relatively high leakage rate similar to that of line D, but with a relatively low energy loss, similar to line A. In other words, the pressure evolution in line B is largely driven by the energy loss while the pressure evolution in line C is largely driven by leakage rate. This is evident from the shapes of the lines, in which line B shows an initial drop in pressure due to a large change in temperature, but then levels off as the temperature of fluid in the hydraulic accumulator 25 approaches its equilibrium value. Line C, on the other hand, shows a lower initial decrease in pressure due to energy loss than with line B, but the pressure in line C continues to decrease throughout the flight of the aircraft 1 due to the continuous leakage of hydraulic fluid from the hydraulic accumulator.

It will be appreciated that, by using the model, it is possible to match the pressure information obtained from the pressure sensor 37 during the flight of the aircraft 1 to one of the lines of pressure evolution comprised in the model. The estimated leakage rate and energy loss can then be determined based on the specific energy loss and leakage rate associated with the matched line. Moreover, obtaining the pressure information over a greater period of time will provide a greater distinction as to which of the relationships in the model the measured pressure evolution best corresponds. For example, pressures obtained from the pressure sensor 37 over a small initial period of time may show a pressure evolution that could correspond to any one of a plurality of different relationships (i.e., different lines) in the model. However, obtaining such pressure information over a longer period of time will make it more clear to what extent the pressure continues to decrease, e.g., due to leakage, and to what extent the pressure begins to level off, thereby narrowing the range of possible lines to which the obtained pressure information corresponds. In the present example, the pressure information is obtained over the course of 3 hours, but in other examples, the pressure information may be obtained over the course of at least an hour, such as up to 2 hours, such as up to 3 hours, such as up to 4 hours.

Pressure-time relationships such as those provided in FIG. 4 are also provided in the model for respective variants in temperature obtained in tests of a representative aircraft 1 comprising the representative accumulator. Specifically, the temperatures comprised in the model are obtained from temperature sensors of the representative aircraft corresponding to those of the aircraft sensor system 30. For instance, the model comprises relationships between pressure and time for variants in temperature external to a representative pressurized bulkhead, such as a representative cabin, of the representative aircraft, temperature in a representative landing gear bay of the representative aircraft, temperature of representative brakes of the representative aircraft, and temperature of fluid delivered to the representative hydraulic accumulator of the representative aircraft. By utilizing such temperatures, the model is able to account for transfers of heat from the pressurized bulkhead 15a of the aircraft 1, into the landing gear bay 14, and then into the external atmosphere, as well as transfers of heat from hydraulic fluid supplied to the hydraulic accumulator 25 to the gas in the hydraulic accumulator 25, and from the hydraulic fluid and/or gas in the hydraulic accumulator 25 to the atmosphere in the landing gear bay, without actually needing to determine such levels of heat flow. Thus, by utilizing such temperatures, the model may provide a more accurate estimation of the leakage rate and energy loss than without utilizing such temperatures.

The particular model in this example utilizes a machine learning model trained on the pressure and temperature data comprised in the model, which allows the model to, for example, select relationships between pressure and time for conditions matching those of the current flight as sensed by each of the sensors 31, 32, 34, 35, 36, 37 in the aircraft sensor system 30. The more parameters that are measured and compared, the more accurate the determination of the leakage rate and energy loss will be.

It will be appreciated that variations and modifications to the above-described embodiment may be made within the scope of the disclosure herein as defined by the appended claims.

For instance, in some examples of the method 300, in response to the estimated power meeting or dropping below the threshold power, the method 300 comprises the monitor 200 instructing the flight controller 16 to cause a mission of the aircraft 1 to be adjusted, such as to cause the aircraft to land at an airport that is currently closer to the aircraft 1 than an airport at which the aircraft 1 was previously intending to land, as part of the mission. This may allow the aircraft 1 to land at a time when the available power is above the threshold power, without requiring input or decisions from flight crew.

In some examples, in response to the power meeting or dropping below the threshold power, the method 300 comprises the monitor 200 causing the braking system controller 26 to cause the hydraulic braking system 20 to supply pressurized hydraulic fluid from the pump 21 to the hydraulic accumulator 25, such as by operating the pump 21 and/or opening the refill valve 35. This may “top-up” the hydraulic accumulator 25 to ensure that sufficient hydraulic fluid is contained in the hydraulic accumulator 25 to provide backup braking during a landing event of the aircraft 1. This may be particularly advantageous when the method 300 determines that an observed pressure drop is largely due to a loss of mass (from leakage of hydraulic fluid from the hydraulic accumulator 25) rather than a loss in energy in the hydraulic accumulator 25.

In some examples, in response to the power meeting or dropping below the threshold power, the method 300 comprises the monitor 200 causing, via the hydraulic braking system 26 (and/or the flight controller 16), an operation of the aircraft 1 to be adjusted, such as to reduce an amount of torque applied to the brakes 12 during a landing event at the end of the mission. This may provide braking over a longer period of time in the event that power in the hydraulic accumulator 25 is close to, at, or below the power threshold power, thereby to safely slow the aircraft 1. This may require a longer runway, and so the causing the operation of the aircraft 1 to be adjusted may also comprise causing the aircraft 1 to land at a runway with sufficient landing distance to accommodate braking with such reduced braking torque. Alternatively, instead of causing the aircraft 1 to land at a different runway, the causing the operation of the aircraft 1 to be adjusted may comprise causing the aircraft to touch down nearer to a start of the same runway than it would otherwise. It will be appreciated that the causing the operation of the aircraft 1 to be adjusted may comprise the monitor 200 instructing flight crew to adjust how they operate the aircraft, such as to cause flight crew to apply such reduced braking, to land at a different runway, or to touch down nearer to the start of the same runway.

It will be appreciated that any one of the above-described actions performed in response to the power meeting or dropping below the threshold power may alternatively (or in addition) be performed in response to the predicted expected energy loss and/or the predicted expected mass loss meeting or exceeding respective energy loss and mass loss thresholds. Similarly, such actions may be performed in response to an expected energy and/or mass in the hydraulic accumulator, determined based on the respective predicted energy loss and mass loss, meeting, or dropping below, respective energy and/or mass thresholds.

In other examples, the method 300 comprises the monitor 200 providing the estimated power expected to be available during the flight of the aircraft 1, such as during a landing of the aircraft, to the flight deck system 16 for indication to the flight crew via the flight deck display of the flight deck system 17a. In this way, the flight crew may then choose to manually cause operation of the brakes 12 during a landing event of the mission to conserve energy in response to the indication of the estimated available power, and/or may divert the aircraft 1 to a different airport.

It will be appreciated that, in some examples, the method 300 comprises estimating the leakage rate and energy loss without obtaining the temperature information from the aircraft sensor system 30. In particular, the method 300 may comprise estimating the leakage rate and energy loss based only the obtained pressure information from the pressure sensor 37 and the model of relationships between pressure and time for respective variants in the leakage rate and energy loss, such as those shown in FIG. 4. Nevertheless, by utilizing such temperatures, a speed and/or accuracy with which the leakage rate and energy loss are determined may be increased. Moreover, it will be appreciated that the pressure information may be obtained in other locations in the hydraulic system 20, such as in the second fluid line 28 downstream of the refill valve 23 and upstream of the hydraulic accumulator 25, and/or downstream of the hydraulic accumulator 25 and upstream of the valve system 24. In such locations, the pressure information would still be representative of a pressure of fluid in the hydraulic accumulator.

In some examples, instead of estimating the energy loss (and instead of, or in addition to, the model comprising pressure relationships for variants in energy loss), the method 300 may comprise estimating a reduction in temperature of fluid in the hydraulic accumulator 25, such as a reduction in temperature in the hydraulic fluid and/or the gas in the hydraulic accumulator 25. Such a reduction in temperature may be representative of a reduction in energy in the hydraulic accumulator 25, and/or may subsequently be used to determine such a reduction in energy.

It will also be appreciated that the four lines A, B, C, D shown in FIG. 2 are illustrative only, and that the curves may follow other paths. Moreover, in practice, a number of pressure-time relationships in the model—as represented pictorially by the respective lines in FIG. 2—could be up to 100, up to 1000, up to 10,000, or more than 10,000.

It is to be noted that the term “or” as used herein is to be interpreted to mean “and/or”, unless expressly stated otherwise.

It should be understood that modifications, substitutions, and alternatives of the invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A computer-implemented method of estimating characteristics of a hydraulic accumulator of an aircraft, the method comprising:
obtaining pressure information representative of a pressure of hydraulic fluid in the hydraulic accumulator at a plurality of times during a mission of the aircraft; and
estimating the characteristics based on the pressure information and a model comprising relationships between pressure and time for respective variants of the characteristics.

2. The computer-implemented method of claim 1, wherein the characteristics comprise:
at least one mass characteristic representative of a loss of mass of fluid in the hydraulic accumulator; and
at least one energy characteristic representative of a loss of energy in the hydraulic accumulator.

3. The computer-implemented method of claim 1, wherein the model is based on data comprising simulated and/or experimental values of pressure over time for the respective variants of the characteristics.

4. The computer-implemented method of claim 1, comprising:
obtaining temperature information representative of an external temperature external to the hydraulic accumulator at each of the plurality of times during the mission of the aircraft; and
estimating the characteristics based on the pressure information, the temperature information, and the model, wherein the model comprises relationships between pressure and time for respective variants of the characteristics and respective variants of the external temperature.

5. The computer-implemented method of claim 1, comprising estimating a change in at least one of the characteristics during an upcoming portion of the mission of the aircraft.

6. The computer-implemented method of claim 5, wherein the estimating the change in the at least one of the characteristics comprises estimating a change in energy stored in and/or mass of hydraulic fluid in the hydraulic accumulator during the upcoming portion of the mission of the aircraft.

7. The computer-implemented method of claim 5, comprising estimating a period of time until an energy, mass, and/or power able to be provided by the hydraulic accumulator meets or drops below a respective threshold energy, threshold mass and/or threshold power.

8. The computer-implemented method of claim 5, comprising performing an action based on the estimated change in the at least one of the characteristics, wherein the action comprises any one or more of:
causing provision of a status of the hydraulic accumulator to flight crew;
causing provision of instructions to flight crew; and
causing control of one or more systems of the aircraft.

9. The computer-implemented method of claim 5, comprising estimating a maximum flight duration of an upcoming mission of the aircraft.

10. A computer program comprising instructions which, when the program is executed by a processor, cause the processor to perform the method of claim 1.

11. A non-transitory computer-readable storage medium comprising instructions which, when executed by a processor, cause the processor to perform the method of claim 1.

12. A data processing apparatus comprising a processor configured to perform the method of claim 1.

13. A monitoring system comprising the data processing apparatus of claim 12 and a pressure sensor configured to detect the pressure information representative of the pressure of hydraulic fluid in the hydraulic accumulator.

14. A hydraulic system comprising the data processing apparatus of claim 12 and the hydraulic accumulator.

15. An aircraft system comprising the monitoring system of claim 13 and a hydraulic system comprising the data processing apparatus.

16. An aircraft comprising the data processing apparatus of claim 12.

17. An aircraft comprising the monitoring system of claim 13.

18. An aircraft comprising the hydraulic system of claim 14.

19. An aircraft comprising the aircraft system of claim 15.
